(19) United States
(12) Patent Application Publication
(10) Pub. No.: US 2014/0027217 A1
(43) Pub. Date: Jan. 30, 2014

(54) ENERGY HARVESTING SHOCK ABSORBER AND METHOD FOR CONTROLLING SAME

(71) Applicant: Vytautas Bucinskas, Vilnius (LT)

(72) Inventor: Vytautas Bucinskas, Vilnius (LT)

(21) Appl. No.: 13/560,985

(22) Filed: Jul. 27, 2012

(51) Int. Cl. F16F 9/53; G05B 15/00

(52) U.S. Cl. 188/267.2; 700/280

(57) ABSTRACT

An energy harvesting shock absorber includes first and second body portions, where the second body portion defines a fluid chamber. A piston located in the fluid chamber divides the fluid chamber into first and second regions. A rod mechanically couples the piston to the first body portion. A coil surrounds at least a portion of the fluid chamber. A ferromagnetic fluid is in the fluid chamber for moving to induce a change in magnetic flux in the coil, to lubricate an inner surface of the fluid chamber, and to damp relative motion between the first and second body portions.

### RELATED APPLICATIONS

This application is related to U.S. patent application Ser. No. (not yet assigned), Docket No. 1896/3, entitled “CHAOTIC VIBRATION ENERGY HARVESTER AND METHOD FOR CONTROLLING SAME” filed on even date herewith, the disclosure of which is incorporated herein by reference in its entirety.

### TECHNICAL FIELD

The subject matter described herein relates to energy harvesting systems. More particularly, the subject matter described herein relates to an energy harvesting shock absorber and a method for controlling such a shock absorber.

### BACKGROUND

Shock absorbers damp vibrations between moving parts by dissipating kinetic energy. For example, automobile shock absorbers typically include a fluid or gas filled chamber that dissipates kinetic energy through fluid friction or compression of a gas. Other than damping vibrations, conventional shock absorbers do not put the kinetic energy to which they are suscepted to beneficial use.

Vibrational energy harvesting systems harvest energy from vibrational movement by converting kinetic energy into electrical energy. Typical energy harvesting systems include a permanent magnet and a coil. Vibrational movement of the system causes the permanent magnet to move with respect to the coil and induce a current in the coil. The induced current can be used to power an external system, such as a sensor, in automobile applications.

Existing energy harvesting systems lack one or more features necessary to operate efficiently in the environment of a shock absorber. For example, some vibrational energy systems may not achieve the entire frequency range needed to efficiently harvest energy from an automobile. Another problem that exists with shock absorbers is the need to lubricate sliding surfaces of shock absorber components. Still another problem with energy harvesting in shock absorbers is controlling energy harvesting with respect to damping, as optimizing energy harvesting and optimizing damping are often competing goals.

Accordingly in light of these difficulties, there exists a need for an energy harvesting shock absorber and a method for controlling such a shock absorber.

### SUMMARY

An energy harvesting shock absorber includes first and second body portions, where the second body portion defines a fluid chamber. A piston located in the fluid chamber divides the fluid chamber into first and second regions. A rod mechanically couples the piston to the first body portion. A coil surrounds at least a portion of the fluid chamber. A ferromagnetic fluid is in the fluid chamber for moving to induce a change in magnetic flux in the coil, to lubricate an inner surface of the fluid chamber, and to damp relative motion between the first and second body portions.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### BRIEF DESCRIPTION OF THE DRAWINGS

The subject matter described herein will now be explained with reference to the accompanying drawings of which:

FIG. 1A is a diagram of an energy harvesting shock absorber according to an embodiment of the subject matter described herein;

FIG. 1B is a top view of a piston for an energy harvesting shock absorber according to an embodiment of the subject matter described herein;

FIG. 2 is schematic diagram of an energy harvesting shock absorber according to an embodiment of the subject matter described herein;

FIG. 3 is a block diagram of a system for controlling an energy harvesting shock absorber according to an embodiment of the subject matter described herein; and

FIG. 4 is a flow chart illustrating an exemplary system for controlling an energy harvesting shock absorber according to an embodiment of the subject matter described herein.

### DETAILED DESCRIPTION

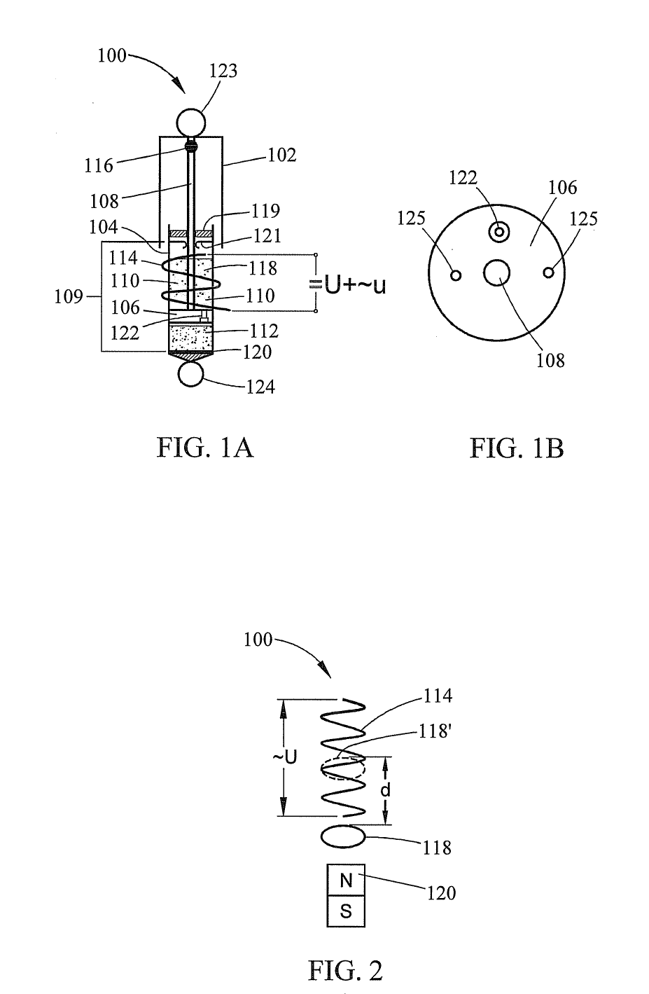

According to the subject matter described herein, an energy harvesting shock absorber and a method for controlling such a shock absorber is provided. FIG. 1A is a sectional view of an energy harvesting shock absorber according to an embodiment of the subject matter described herein. Referring to FIG. 1A, a shock absorber 100 includes a first body portion 102 that is mechanically coupled to a second body portion 104. In particular, first body portion 102 is coupled to second body portion 104 through a piston 106 and a rod 108. Second body portion 104 forms an internal fluid chamber 109 that piston 106 divides into an upper region 110 and a lower region 112. A coil 114 surrounds at least portion of the fluid chamber. A force sensor 116 may be located on rod 108 to sense forces exerted on to shock absorber by the system in which it is installed. Force sensor 116 may provide force feedback to a control system to allow precise control of the level of energy harvesting from shock absorber 100 and the amount of damping force applied by shock absorber 100. In one example, shock absorber may be mounted to an automobile. At 55 mph, force is applied to shock absorber 100 at a frequency of 15 Hz, harvested power is about 120 W, and power lost due to damping is between 100 W and 150 W.

According to an aspect of the subject matter described herein, fluid chamber 109 may be at least partially filled with a ferromagnetic fluid 118. Ferromagnetic fluid 118 may be a synthetic oil with ferromagnetic nanoparticles suspended in the oil. An example of a ferromagnetic fluid suitable for use with embodiments of the subject matter described herein is the EFH series available from Ferrotech Corporation of New Castle, Pa. Ferromagnetic fluid 118 may function as a mechanism for generating a change in magnetic flux, as a lubricant, and as a kinetic energy damping agent. For example, when piston 106 moves within fluid chamber 109, ferromagnetic fluid 118 may be forced through holes in piston 106 between regions 110 and 112 of fluid chamber 109. The movement of ferromagnetic fluid 118 within fluid chamber 109 changes the magnetic flux in the volume surrounded by coil 114 and induces a current in coil 114. The induced current may be harvested by an energy harvesting control system, as will be described in detail below. The friction of fluid flowing through the holes in piston 106 may damp the kinetic energy generated by shock absorber 100 when shock absorber is coupled to a mechanical system. Ferromagnetic fluid 118 may also lubricate there interior walls of fluid chamber 109 to reduce frictional wear caused by movement of piston 106 within fluid chamber 109.

Shock absorber 100 may further include permanent magnets 119 and 120 at opposing ends of fluid chamber 109. Permanent magnets 119 and 120 may provide a bias flux that changes when fluid 118 moves within fluid chamber 109. Fluid chamber 109 may also include a seal 121 that seals around rod 108 to prevent leakage of ferromagnetic fluid 118. Piston 106 may also include an electromagnetic valve 122 and holes to prevent movement of ferromagnetic fluid 118 between upper and lower regions of fluid chamber 109.

Energy harvesting shock absorber 100 may also include attachment members 123 and 124 for connecting to a system whose vibration is being damped. For example, attachment members 123 and 124 may be eyelets that are configured to receive through bolts or pins connected to a mechanical system. In an automobile, eyelet 123 may connect to the frame and eyelet 124 may connect to the suspension. Other applications of energy harvesting shock absorber 100 include motorcycles, trucks, railroad coaches, engine suspensions, and stationary objects, such as buildings, bridges, or other structures. The energy harvested by shock absorber 100 may be used to power diagnostic systems or any other suitable application.

As stated above, movement of ferromagnetic fluid 118 within the volume surrounded by coil 114 causes a change in magnetic flux. To allow such movement, piston 106 may include one or more holes or apertures located in its main body to allow fluid to pass through piston 106. FIG. 18 is a top view of piston 106 illustrating holes 125 through which ferromagnetic fluid 118 may pass. In the illustrated example, two holes 125 are illustrated. However, any number of holes 125 may be included without departing from the scope of the subject matter described herein. Electromagnetic valve 122 may also be opened or closed to increase or decrease fluid flow between upper and lower regions of fluid chamber 109.

In FIG. 1, the symbol U represents a damping DC voltage applied to the coil and the symbol u represents the harvested AC voltage generated by the change in magnetic flux, which induces a current and a corresponding voltage in coil 114.

FIG. 2 is a schematic diagram of an energy harvesting shock absorber according to an embodiment of the subject matter described herein. Referring to FIG. 2, coil 114, permanent magnet 120, and fluid drop 118 are shown. The remaining components of shock absorber 100 are omitted for simplicity. Drop of ferromagnetic fluid 118 travels a distance, represented by the variable d, to a new position, represented by fluid drop 118′. U represents the damping DC voltage applied to the coil. As ferromagnetic fluid drop 118 moves to the position of fluid drop 118′, the current induced in coil 114 is proportional to the change in magnetic flux caused by the motion, which is in turn proportional to the velocity of movement of ferromagnetic fluid drop 118. Changes in direction of fluid drop 118 causes a change in direction of induced current in coil 114. Thus, the voltage produced across terminals of coil 114 and supplied to an external system is an AC voltage.

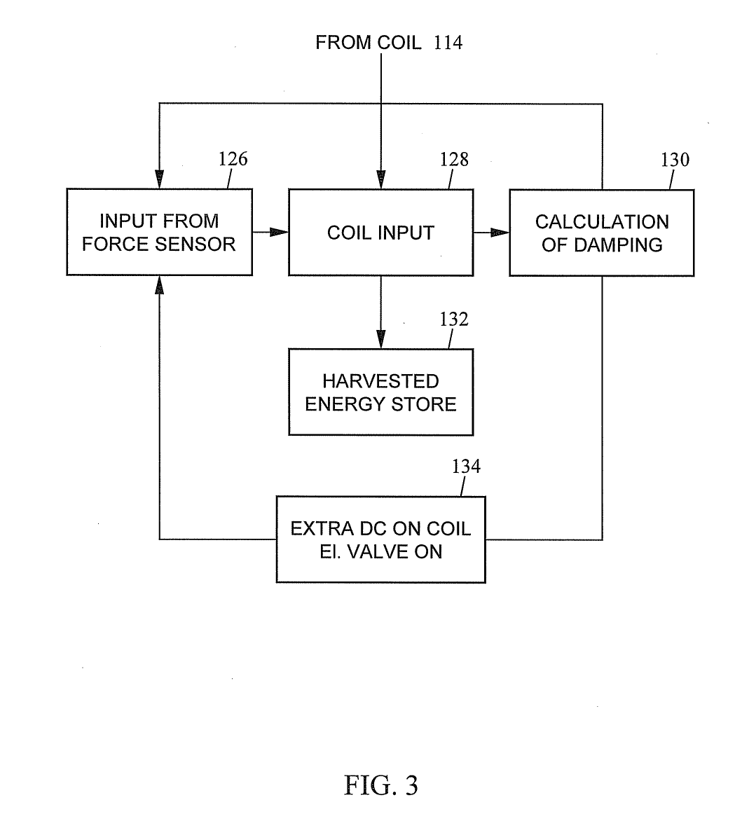

FIG. 3 is a block diagram of a control system for controlling damping and energy harvesting by shock absorber 100. The control system may be coupled to force sensor 116 and to coil 114. In FIG. 3, an input module 126 receives input from force sensor 116 and a coil input module 128 receives input from coil 114 in the form of induced current and/or voltage. A damping calculator 130 receives the input from the coil and the force sensor and determines how much damping to apply to the system. For example, damping calculator may measure the frequency, amplitude, or phase of the damping and determine how much the actual damping level differs from a desired level. Damping calculator 130 may adjust the damping by changing the DC voltage U, changing the amount of energy harvesting, opening or closing valve 122, or any combination thereof. Harvested energy may be stored in harvested energy store 132. The signal to change the DC voltage applied to the coil, open or close the valve, or change the energy harvesting may be provided to input module 126 via feedback mechanism 134. Input module 126 may change the appropriate parameter based on the signal.

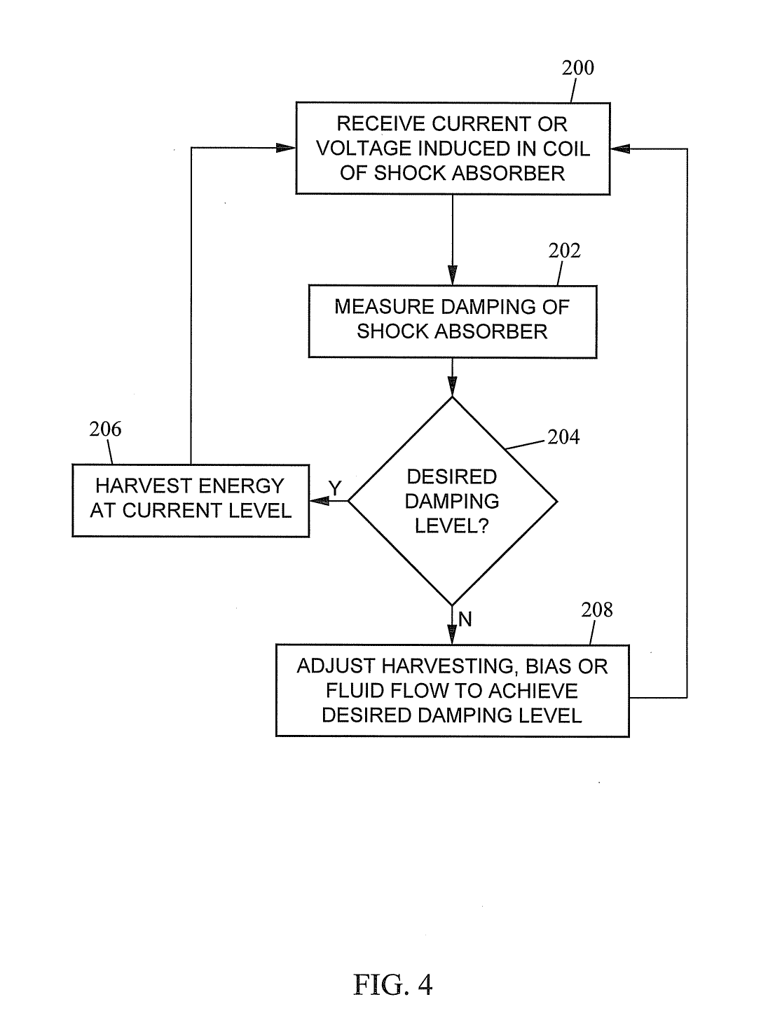

FIG. 4 is a flow chart illustrating exemplary steps for controlling an energy harvesting and shock absorber according to an embodiment of the subject matter described herein. Referring to FIG. 4, the method includes receiving coil current or voltage induced by an energy harvesting shock absorber. For example, in FIG. 1A, current or voltage induced in coil 114 may be received by the control system illustrated in FIG. 3. In step 202, the damping of the shock absorber is measured, for example, by force sensor 116 illustrated in FIG. 1A. The frequency, amplitude, phase, or any other parameter of the damping may be measured. Combinations of parameters may also be measured. In step 204, it is determined whether the damping currently being performed is desired. For example, it may be desirable to maintain the frequency or amplitude of travel by piston 106 within a desired range. If the damping is at the desired level, control proceeds to step 206 where energy is continued to be harvested at the current level and then to step 200 where the process is repeated. If the damping is not being performed at the desired level, control proceeds to step 208 where energy harvesting, bias voltage, and/or fluid flow are adjusted to achieve the desired damping. For example, extra DC may be applied to the coil to increase the damping, DC voltage applied to the coil may be reduced to reduce the damping, valve 122 may be opened or closed to change the fluid flow between the chambers, or energy harvesting may be increased or decreased to reduce or increase the damping.

Shock absorber 100 may be coupled to any suitable mechanical system where damping is desired. Examples of mechanical system to which shock absorber 100 may be coupled include automobiles, trains, motorcycles, engine suspensions—used both in engines for transport and stationary systems. Power harvested from shock absorber 100 may be used to power an external system. For example, power harvested from shock absorber 100 may be used to power one or more lights in an automobile or to power diagnostic systems on a train.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. An energy harvesting shock absorber comprising:
a first body portion;
a second body portion defining a fluid chamber;
a piston located in the fluid chamber and dividing the fluid chamber into first and second regions;
a rod that mechanically couples the piston to the first body portion;
a coil surrounding at least a portion of the fluid chamber; and
a ferromagnetic fluid located in the fluid chamber for moving within a volume surrounded by the coil to induce a current in the coil, for lubricating an interior surface of the fluid chamber, and for damping relative motion between the first and second body portions.

2. The energy harvesting shock absorber of claim 1 wherein the ferromagnetic fluid comprises a synthetic oil having ferromagnetic nanoparticles suspended in the oil.

3. The energy harvesting shock absorber of claim 1 comprising a control system coupled to the coil for controlling damping by the shock absorber and energy harvesting.

4. The energy harvesting shock absorber of claim 3 wherein the control system controls an amount of damping of the relative motion between the first and second body portions by varying one or more of:
an amount of energy harvested from the coil,
a bias voltage applied to the coil, and
flow of the ferromagnetic fluid within the fluid chamber.

5. The energy harvesting shock absorber of claim 4 wherein the control system increases the bias voltage applied to the coil to increase an amount of damping of the relative motion between the first and second body portions.

6. The energy harvesting shock absorber of claim 3 comprising a force sensor coupled to the rod for providing an indication of the damping to the control system.

7. The energy harvesting shock absorber of claim 1 wherein the piston includes at least one hole for allowing movement of the ferromagnetic fluid between the first and second regions of the fluid chamber.

8. The energy harvesting shock absorber of claim 3 comprising a valve located in the piston, wherein the control system opens and closes the valve to control flow through the piston and thereby to control the damping.

9. A method for controlling energy harvesting shock absorber comprising:
receiving input indicative of damping being applied by an energy harvesting shock absorber comprising a fluid chamber with a ferromagnetic fluid located in the fluid chamber and a coil surrounding the fluid chamber;
harvesting energy from the coil created by movement of the ferromagnetic fluid within a region surrounded by the coil;
determining whether the damping being performed by the energy harvesting shock absorber is at a desired level; and
in response to determining that the damping is not at a desired level, changing at least one of: a bias voltage applied to the coil, a level of energy harvesting, and flow of the ferromagnetic fluid within the region surrounded by the coil.

10. The method of claim 9 wherein the ferromagnetic fluid comprises a synthetic oil having ferromagnetic nanoparticles suspended in the oil.

11. The method of claim 10 comprising using the ferromagnetic fluid to lubricate an interior wall of a fluid chamber of the shock absorber.

12. The method of claim 9 wherein changing the flow of the ferromagnetic fluid comprises opening or closing a valve in a piston that divides the fluid chamber into first and second regions.

13. The method of claim 9 wherein receiving the input indicative of the damping comprises receiving the input from a force sensor.

14. A non-transitory computer readable medium having stored thereon executable instructions that when executed by the processor of a computer controls the computer to perform steps comprising:
receiving input indicative of damping being applied by an energy harvesting shock absorber comprising a fluid chamber with a ferromagnetic fluid located in the fluid chamber and a coil surrounding the fluid chamber;
harvesting energy from the coil created by movement of the ferromagnetic fluid within a region surrounded by the coil;
determining whether the damping being performed by the energy harvesting shock absorber is at a desired level; and
in response to determining that the damping is not at a desired level, changing at least one of: a bias voltage applied to the coil, a level of energy harvesting, and flow of the ferromagnetic fluid within the region surrounded by the coil.
